(19) United States
(12) Patent Application Publication
(10) Pub. No.: US 2009/0112364 A1
(43) Pub. Date: Apr. 30, 2009

(54) Chemical treatment system and method

(75) Inventors: Yu-Gene T. Chen, Glendale, AZ (US); Ron Dinello, Phoenix, AZ (US); Russell Kane, Houston, TX (US)

Correspondence Address: Honeywell International Inc.;Patent Services Department, 101 Columbia Road, Morristown, NJ, 07962, US

(73) Assignee: HONEYWELL INTERNATIONAL INC.

(21) Appl. No.: 11/981,034

(22) Filed: Oct. 31, 2007

(51) Int. Cl. G05B 21/00

(52) U.S. Cl. 700/266

(57) ABSTRACT

A chemical treatment system that injects a dosage chemical solution into a process. A condition of the process is sensed by a sensor, communicated to a controller and used as a basis for varying in real time the dosage of the chemical solution. The sensor, the controller, a pump and the process are disposed in a closed control loop. The controller controls the operation of the pump (speed, duty cycle and the like) to vary the dosage based on the sensed condition, which is disclosed as a corrosion and/or scale of an element of the process, although other conditions can control the dosage as well.

### FIELD OF THE INVENTION

This invention relates to a system and method for chemical treatment of a process.

### BACKGROUND OF THE INVENTION

Chemical treatment management systems are used in chemical and refinery plants for major operational areas such as process units, cooling water systems, steam generating systems and wastewater systems and other systems. The chemical treatments are used for corrosion and scale control (corrosion and scale inhibiting chemicals), bio-control (biocides and disinfectants), pH control (pH adjusters), foaming control (anti-foaming and defoamers), emulsion control (emulsion breakers), solids control (coagulants and flocculants) and others.

Most chemical treatment systems are small stand-alone systems monitored by outside operators. These systems are often neglected by operators and are looked after by the chemical treatment vendor on a periodic basis. FIG. 1 shows a process 20 that receives chemical treatment from a typical chemical injection system 30. System 30 includes a skid-mounted chemical storage tank or drum 32 with a fill line 34, a drain line 36 and a sight glass 38 for visual inspection of drum inventory. The drum inventory contains a solution of the chemicals for the treatment of process 20. A chemical injection pump 40 with a calibration tube 42 pumps a desired treatment dosage from drum 32 via an injection valve 44 for insertion into process 20. System 30 is operated almost entirely manually making it prone to operator error and neglect. Significant incidents have been reported such as inadvertent discharge of the entire drum inventory to the process sewer or cooling tower basin, excess dosage to process 20 that caused high chemical concentrations in process water draws. All of these incidents resulted in additional costs and harm to the plant's wastewater treatment system.

Low inventory can cause the loss of treatment with its associated cost in terms of increased corrosion, reduced throughput caused by foaming, etc. Expedited delivery of additional chemicals can add substantially to the cost of chemical treatment. High inventories typically indicate the loss of dosing over time.

There is a need for a chemical treatment system and method for a process that overcome the above mentioned problems.

There is a need for a chemical treatment system and method that overcome the above mentioned problems for the control of corrosion and scale.

### SUMMARY OF THE INVENTION

A chemical treatment system of the present invention injects a chemical solution into a process. The chemical treatment system comprises a chemical tank containing the chemical solution. A pump is disposed to provide a dosage of the chemical solution from the tank to the process. A sensor and a controller are disposed in a closed loop with the process and the pump to vary in real time the dosage of the chemical solution provided by the pump based on a condition of the process sensed by the sensor and communicated to the controller.

In one embodiment of the chemical treatment system of the present invention, the dosage is determined by a speed of the pump. The controller provides a speed control signal proportional to the condition to the pump.

In another embodiment of the chemical treatment system of the present invention, the controller correlates a current value and a previous value of the sensed condition to determine a variance upon which a change is made to the dosage.

In another embodiment of the chemical treatment system of the present invention, the sensor is in wireless communication with the controller.

In another embodiment of the chemical treatment system of the present invention, the condition is a corrosion condition. The chemical solution contains a corrosion inhibitor.

In another embodiment of the chemical treatment system of the present invention, the condition is at least one of a corrosion rate and a pitting condition.

In another embodiment of the chemical treatment system of the present invention, the dosage is controlled in a linear region of a curve of corrosion rate vs. dosage.

In another embodiment of the chemical treatment system of the present invention, the dosage is also controlled in at least one non-linear region of the curve.

In another embodiment of the chemical treatment system of the present invention, the sensor communicates a plurality of parameters of the condition to the controller for control of the dosage based on the plurality of parameters.

In another embodiment of the chemical treatment system of the present invention, the plurality of parameters comprises a corrosion rate and a pitting condition.

In another embodiment of the chemical treatment system of the present invention, the sensor is one of a plurality of sensors that sense a plurality of conditions of the process and communicates the plurality of conditions to the controller for control of the dosage based on the plurality of conditions.

A method of the present invention injects a chemical solution into a process. The method comprises providing a dosage of the chemical solution to the process using a pump to pump the chemical solution from a tank to the process, and sensing a condition of the process, and varying the dosage in real time based on the sensed condition by varying the operation of the pump.

In one embodiment of the method of the present invention, the condition is sensed by a sensor and communicated to a controller, and where the controller controls the pump to vary the dosage based on the sensed condition.

In another embodiment of the method of the present invention, the process, the sensor, the controller and the pump are disposed in a closed control loop.

In another embodiment of the method of the present invention, the dosage is determined by a speed of the pump. The controller provides a speed control signal proportional to the condition to the pump.

In another embodiment of the method of the present invention, the controller correlates a current value and a previous value of the sensed condition to determine a variance upon which a change is made to the dosage.

In another embodiment of the method of the present invention, the sensor is in wireless communication with the controller.

In another embodiment of the method of the present invention, the condition is a corrosion condition. The chemical solution contains a corrosion inhibitor.

In another embodiment of the method of the present invention, the condition is at least one of a corrosion rate and a pitting condition.

In another embodiment of the method of the present invention, the dosage is controlled in a linear region of a curve of corrosion rate vs. dosage.

In another embodiment of the method of the present invention, the dosage is also controlled in at least one non-linear region of the curve.

In another embodiment of the method of the present invention, the sensor communicates a plurality of parameters of the condition to the controller for control of the dosage based on the plurality of parameters.

In another embodiment of the method of the present invention, the plurality of parameters comprises a corrosion rate and a pitting condition.

In another embodiment of the method of the present invention, the sensor is one of a plurality of sensors that sense a plurality of conditions of the process and communicates the plurality of conditions to the controller for control of the dosage based on the plurality of conditions.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a diagram of a prior art chemical treatment system;

FIG. 2 is a diagram of a chemical treatment system of the present invention; and

FIG. 3 is a graph that depicts corrosion rate as a function of treatment dosage for the chemical treatment management system of FIG. 2.

### DESCRIPTION OF THE PREFERRED EMBODIMENT

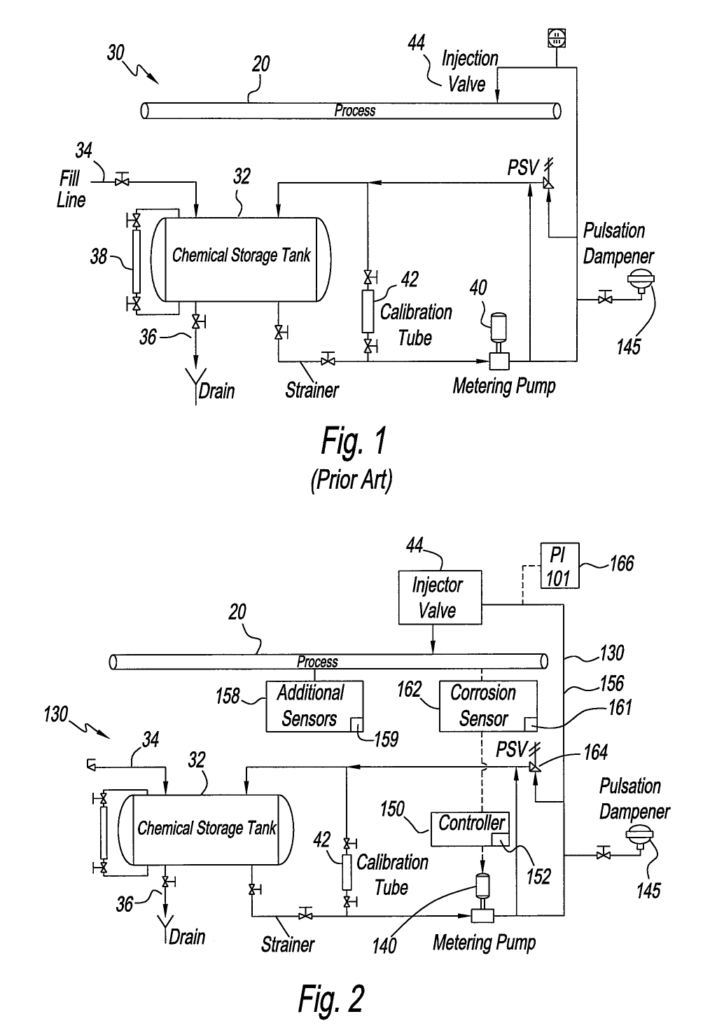

Referring to FIG. 2, a chemical treatment system 130 of the present invention is disposed to control chemical treatment of a process 20. Chemical treatment system 130 includes components that are the same as components included in FIG. 1 and that bear like reference numerals.

Chemical treatment system 130 comprises a vessel, shown as a skid-mounted drum 32 with a fill line 34, a drain line 36, a calibration tube 42 and a sight glass 38 for visual inspection of drum inventory. In a preferred embodiment a corrosion inhibitor is supplied to drum 34 via fill line 34. The corrosion inhibitor may vary from one process to another.

Chemical treatment system 130 further comprises a corrosion sensor 162 disposed to sense corrosion and/or scaling in process 20 and to supply an output signal that is a function of the corrosion rate. Corrosion sensor 162 may be any suitable corrosion sensor. For example, corrosion sensor 162 may be a SmartCet™ probe, SmartCet™ being a trademark of Honeywell International, Inc.

Chemical treatment system 130 further comprises a chemical injection pump 140 and a controller 150 that are connected in a closed loop with corrosion sensor 162 to control dosage injection of the chemical inhibitor into process 20. Controller 150 may be any suitable controller. Controller 150, for example, may be a Profit Controller® device, or Profit Loop™ controller available from Honeywell International Inc. Profit Controller is a registered trademark of and Profit Loop is a trademark of Honeywell International Inc.

Chemical injection pump 140 is a variable speed pump having a variable speed drive that is controlled automatically by controller 150 to pump a desired dosage of the corrosion inhibitor via a line 156 and an injection valve 44 for insertion into process 20. For example, the corrosion inhibitor is injected into a wastewater system (not shown) in process 20. That is, the desired dosage is a flow rate that is determined by the speed of chemical injection pump 140.

Chemical treatment system 130 further comprises a pulsation dampener 145, an over pressure protection valve 164 and a pressure indicator 166, each being coupled to line 156. Pulsation dampener 145 dampens pulsation from chemical injection pump 145.

Corrosion sensor 162, for example, provides an output signal that is proportional to a corrosion rate that occurs to an element (e.g., a vessel, a pipe, etc.) in process 20. Controller 150 uses the output signal from corrosion sensor 162 to generate an output or dosage control signal that controls the speed of chemical injection pump 140. For some pumps, the controller output signal is a 4 to 20 milli-amperes current pulse signal. For other pumps, the output signal may differ. Thus, chemical storage tank or drum 32, chemical injection pump 140, injector valve 44, process 20, corrosion sensor 162 and controller 150 are disposed in a closed loop control to meter the chemical inhibitor solution from chemical storage tank 32 to process 20 in a dosage flow rate based on the corrosion rate detected by corrosion sensor 162. Controller 150 correlates or compares the current value of the corrosion signal with its value at a previous correlation time. If greater, the dosage is increased by increasing the pump speed. If less, the dosage is decreased by decreasing the pump speed. If there is no change, the current pump speed is maintained.

Corrosion sensor 162 could also, or alternatively, provide an output signal that is proportional to pitting of a surface of an element in process 20. Since pitting is indicative of an advanced state of corrosion, controller 150 may be programmed to respond to the pitting signal to change the pump speed by larger increments. For example, if a normal incremental speed change of X is made in response to the corrosion signal, then in response to the pitting signal the speed change increment is larger by as much as 10× or more.

Corrosion sensor 162 can also provide an output B-value, known as the Stern Geary Constant. The B-value may optionally be used by controller 150 as a disturbance variable to adjust the dosage of the chemical solution (and/or pressure, temperature, flow) by fine adjustment of the speed of chemical injection pump 140, thereby controlling the output or conditions of process 20 to reduce corrosion rate, pH, and/or overall cost per unit of the product of process 20.

Chemical injection pump 140 may be any variable speed pump, such as any off-shelf injection pump that is controllable by an input signal to vary pump speed or flow rate. The pump size, impeller and manufacturer may vary from process to process as well as the chemical being injected. Alternatively, chemical injection pump 140 may simply be a manual metering pump with its micrometer screw adjustment replaced by an electronic actuator that would be controlled by controller 150. This would allow automatic flow rate adjustment in response to an output signal from controller 150.

Corrosion sensor 162 preferably has a wireless transmitter 161 that transmits its output signal(s) to controller 150. Controller 150 has a wireless transceiver that receives the transmitted signals from wireless transmitter 161. Alternatively wireless transmitter 161 and/or wireless transceiver 152 can be independent units that are in wired communication with corrosion sensor 162 and controller 150, respectively. The wireless communication between corrosion sensor 162 and controller 150 together with the closed loop control provide a real time control as distinguished from the manually controlled system described in the Background of the Invention.

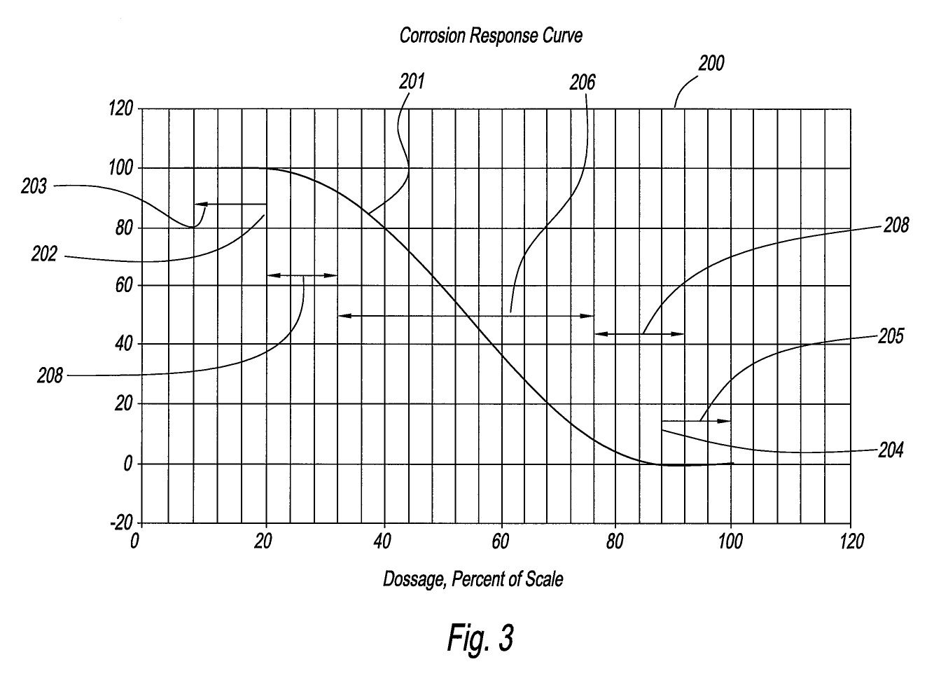

Referring to FIG. 3, a graph 200 depicts a curve 201 of corrosion rate as a function of corrosion inhibitor dosage. Curve 201 comprises a linear region or range 206 subtended by non-linear ranges 203 and 205. A dosage 202 is a minimum dosage, less than which no reduction in corrosion rate occurs. A dosage 204 is a maximum dosage, greater than which no reduction in corrosion rate occurs. Between dosages 202 and 204 is controllable region or range 206 that is reasonably linear with dosage rate. Regions 208 are transition regions. Controller 150 performs a correlation that allows dosages in the controllable or linear range 206 as well as in the non-linear ranges 203 and 205.

The objective of closed loop control is to maintain the measured corrosion rate at a specified value or within a range. If the corrosion rate is specified as a range (for example, range 206), then an economic objective function can be formulated as a minimum cost function as shown by the following equation:

Cost_{T}+COR*Cost_{COR}+INH*Cost_{INH}

### Where:

Cost_{T} is the total cost, USDollars/Time
COR is the corrosion rate, Length/Time
Cost_{COR} is the cost of corrosion, USDollars/Length
INH is the inhibitor rate, Volume/Time
Cost_{INH} is the cost of the inhibitor, USDollars/Volume

The economic objective serves to optimize inhibitor dosage rate by minimizing corrosion rate and minimizing total cost. There is a trade off the cost of the inhibitor against the equipment life. The tendency is for the objective function to maximize dosage in order to minimize corrosion rate. On the other hand, when corrosion is in a stage in which pitting occurs, the pitting signal output of corrosion sensor 162 may be used to provide a large dosage increase as compared to a normal dosage increase.

Additional sensors 158 of other functionalities may optionally be provided to monitor other conditions of process 20. An output signal from one of the additional sensors 158 can be used in combination with or in place of the output signal of corrosion sensor 162 as an input to controller 150. If controller 150 has multiple inputs, the output signals of additional sensors 158 and corrosion sensor 162 can be used in any desired combination to produce the signal that controls the pump speed. Additional sensors 158 preferably include wireless transmitters to transmit their output signals to controller 150.

Additional sensors 158 may sense other conditions of process 20. For example, in a wastewater system these conditions may include process measurements such as flow rate of the wastewater, temperature, and pressure (e.g., pressure in the tanks, piping and other pressure vessels that make up the process system). Other sensed conditions may include ph, biocide concentration, oxygen scavenger concentration and others.

Calibration of pump 140 can be performed by hand or with a tool. The calibration results can be entered into controller 150 by any suitable input device, such as a handheld device with wired or wireless communication.

The present invention having been thus described with particular reference to the preferred forms thereof, it will be obvious that various changes and modifications may be made therein without departing from the spirit and scope of the present invention as defined in the appended claims.

What is claimed is:

1. A chemical treatment system that injects a chemical solution into a process, said system comprising:
a chemical tank containing said chemical solution;
a pump disposed to provide a dosage of said chemical solution from said tank to said process; and
a sensor and a controller disposed in a closed loop with said process and said pump to vary in real time said dosage of said chemical solution provided by said pump based on a condition of said process sensed by said sensor and communicated to said controller.

2. The chemical treatment system of claim 1, wherein said dosage is determined by a speed of said pump, and wherein said controller provides a speed control signal proportional to said condition to said pump.

3. The chemical treatment system of claim 2, wherein said controller correlates a current value and a previous value of said sensed condition to determine a variance upon which a change is made to said dosage.

4. The chemical treatment system of claim 1, wherein said sensor is in wireless communication with said controller.

5. The chemical treatment system of claim 1, wherein said condition is a corrosion condition, and wherein said chemical solution contains a corrosion inhibitor.

6. The chemical treatment system of claim 1, wherein said condition is at least one of a corrosion rate and a pitting condition.

7. The chemical treatment system of claim 5, wherein said dosage is controlled in a linear region of a curve of corrosion rate vs. dosage.

8. The chemical treatment system of claim 7, wherein said dosage is also controlled in at least one non-linear region of said curve.

9. The chemical treatment system of claim 1, wherein said sensor communicates a plurality of parameters of said condition to said controller for control of said dosage based on said plurality of parameters.

10. The chemical treatment system of claim 9, wherein said plurality of parameters comprises a corrosion rate and a pitting condition.

11. The chemical treatment system of claim 1, wherein said sensor is one of a plurality of sensors that sense a plurality of conditions of said process and communicates said plurality of conditions to said controller for control of said dosage based on said plurality of conditions.

12. A method for injecting a chemical solution into a process comprising:
providing a dosage of said chemical solution to said process using a pump to pump the chemical solution from a tank to said process;
sensing a condition of said process; and
varying said dosage in real time based on said sensed condition by varying the operation of said pump.

13. The method of claim 12, wherein said condition is sensed by a sensor and communicated to a controller, and wherein said controller controls said pump to vary said dosage based on said sensed condition.

14. The method of claim 13, wherein said process, said sensor, said controller and said pump are disposed in a closed control loop.

15. The method of claim 14, wherein said dosage is determined by a speed of said pump, and wherein said controller provides a speed control signal proportional to said condition to said pump.

16. The method of claim 12, wherein said controller correlates a current value and a previous value of said sensed condition to determine a variance upon which a change is made to said dosage.

17. The method of claim 12, wherein said sensor is in wireless communication with said controller.

18. The method of claim 12, wherein said condition is a corrosion condition, and wherein said chemical solution contains a corrosion inhibitor.

19. The method of claim 12, wherein said condition is at least one of a corrosion rate and a pitting condition.

20. The method of claim 19, wherein said dosage is controlled in a linear region of a curve of corrosion rate vs. dosage.

21. The method of claim 20, wherein said dosage is also controlled in at least one non-linear region of said curve.

22. The method of claim 13, wherein said sensor communicates a plurality of parameters of said condition to said controller for control of said dosage based on said plurality of parameters.

23. The method of claim 22, wherein said plurality of parameters comprises a corrosion rate and a pitting condition.

24. The method of claim 13, wherein said sensor is one of a plurality of sensors that sense a plurality of conditions of said process and communicates said plurality of conditions to said controller for control of said dosage based on said plurality of conditions.
